(19) United States
(12) Patent Application Publication
(10) Pub. No.: US 2010/0306230 A1
(43) Pub. Date: Dec. 2, 2010

(54) PERSONAL INFORMATION MANAGEMENT SYSTEM AND PERSONAL INFORMATION MANAGEMENT METHOD

(75) Inventor: Masayoshi Son, Tokyo (JP)

Correspondence Address: MAIER & MAIER, PLLC, 1000 DUKE STREET, ALEXANDRIA, VA, 22314, US

(73) Assignee: SOFTBANK BB CORP., Tokyo (JP)

(21) Appl. No.: 12/445,983

(22) PCT Filed: Oct. 19, 2007
(86) PCT No.: PCT/JP2007/070420

§ 371 Date: Jun. 19, 2009

(30) Foreign Application Priority Data
Oct. 19, 2006 (JP) 2006285596

(51) Int. Cl. G06F 17/30; G06F 3/12

(52) U.S. Cl. 707/769; 358/1.15; 707/E17.014

(57) ABSTRACT

A personal information management system is characterized in describing a telephone number while reading out a coordinate position on an application sheet on which a coded coordinate position on the sheet is printed, transmitting by a mobile phone a handwriting image read out by a digital pen to a database managing server, analyzing by the database managing server image data received by a wireless communication terminal device, extracting the telephone number allocated to the wireless communication terminal device, and, in accordance with the extracted telephone number, detecting personal information associated with the telephone number from a telephone number/address associating type database. With this, in letter mailing service, etc., an opportunity for the exposure of personal information is shortened, so that the possibility of the leakage of personal information is reduced, repetitive descriptions of the same content are avoided, and troublesome work can be eased.

### RELATED APPLICATIONS

The present invention claims priority to international patent application No.: PCT/JP2007/070420, filed Oct. 19, 2007, which claims priority under 35 U.S.C. §119 to Japanese Patent Application No. 2006-285596, filed Oct. 19, 2006, the disclosures of which are incorporated by reference herein in their entirety.

### FIELD OF THE INVENTION

The present invention relates to a personal information management system and a personal information management method which can be used for delivering postal matters and so forth, and managing personal information including the residences and names of individuals by a database managing server located in a network.

### BACKGROUND ART

Heretofore, in the case of postal services of delivering postal matters such as registered mail, certified mail, and packages handled by parcel service, forwarding of postal matters is managed to guarantee the delivery thereof by recording delivery information, i.e., inputting trace information, issuing and transmitting delivery certifications and so forth in the respective steps of delivery from pickup points to end points (for example, refer to Patent Document 1).

[Patent Document 1] Japanese Patent Published Application No. 2006-31140.

### DISCLOSURE OF THE INVENTION

However, in the case of the conventional service of delivering postal matters, it is needed to describe, for each postal matter, personal information such as the residences, names, telephone numbers of the sender and recipient for forwarding the each postal matter. Because of this, in the conventional case, there is a problem that, when a postal matter is picked up and delivered, the personal information is being exposed so that there is a good chance that the personal information is leaked.

In addition to this, the sender has to repeatedly describe the same information such as his own residence each time a postal matter is sent. The redundant procedure which is repeated performed thereby becomes troublesome.

Taking into consideration the above circumstances, it is an object of the present invention to provide a personal information management system and a personal information management method in which it is possible to minimize the chance that the personal information is exposed when a postal matter is delivered and thereby reduce the chance that the personal information is leaked, while the same information need not repeatedly be written to reduce the troublesome burden.

In order to accomplish the object as described above, the personal information management system in accordance with the present invention manages personal information including the residences and names of individuals, and comprises: a personal information database in which are stored personal information including either the residence or the name of each of the individuals and the telephone number assigned to the wireless communication terminal used by the each individual in association with each other; a database managing server located in the network and operable to manage the personal information database; a handwriting image readable sheet on which coordinate positions of the sheet are printed in the form of encoded symbols; a handwriting image reading unit operable to read the coordinate positions while writing a handwriting stoke on the sheet with a writing member; an image data generation unit operable to generate the image of the handwriting written with the writing member on the basis of the coordinate positions read by the handwriting image reading unit; a communication interface provided in the wireless communication terminal and operable to transmit the image data generated by the image data generation unit to the database managing server through the network; and an image analysis unit provided in the database managing server and operable to analyze the image data received through the communication interface, and extract the telephone number assigned to the wireless communication terminal, wherein the database managing server detects the personal information associated with the telephone number from the personal information database on the basis of the telephone number which is extracted by the image analysis unit.

Preferably, in the invention as described above, the communication interface is provided with the functionality of storing and maintaining the telephone number assigned to the wireless communication terminal, and transmitting the telephone number which is stored and maintained to the database managing server when the image data is transmitted, and wherein the database managing server is provided with the functionality of checking the telephone number extracted from the image data against the telephone number stored and maintained in the communication interface and determining whether the personal information can be detected or not on the basis of the consistency therebetween.

In the invention as described above, it is preferred to provide a printing unit which is connected to the database managing server through the network and operable to print the personal information detected by the database managing server.

Preferably, in the invention as described above, a paper identifier is printed on the handwriting image readable sheet in the form of encoded symbols for identifying the handwriting image readable sheet, wherein the handwriting image reading unit and the communication interface are provided with the functionality of acquiring and transmitting the paper identifier, wherein the database managing server is provided with the functionality of transmitting the paper identifier received from the communication interface to the printing unit together with the personal information, and wherein the printing unit is provided with the functionality of printing the paper identifier together with the personal information as received.

Preferably, in the invention as described above, the handwriting image readable sheet is an application sheet which is used for requesting the delivery of a postal matter, and wherein a paper medium to be printed by the printing unit is a transmittal slip which to be attached to the postal matter for showing the destination of the postal matter.

Another aspect of the present invention relates to a personal information management method of managing personal information including the residences and names of individuals by a personal information database in which are stored the personal information including either the residence or the name of each of the individuals and the telephone number assigned to the wireless communication terminal used by the each individual in association with each other, comprising:

(1) a step of writing a handwriting with a writing member on a handwriting image readable sheet on which coordinate positions of the sheet are printed in the form of encoded symbols, and concurrently reading the coordinate positions of the handwriting image readable sheet by a handwriting image reading unit;

(2) a step of generating an image of the handwriting written with the writing member by an image data generation unit on the basis of the coordinate positions read by the handwriting image reading unit, and transmitting the generated image data to the database managing server by the wireless communication terminal through the network;

(3) a step of analyzing the image data received from the wireless communication terminal by an image analysis unit of the database managing server, and extracting the telephone number assigned to the wireless communication terminal; and

(4) a step of detecting the personal information associated with the telephone number from the personal information database on the basis of the telephone number which is extracted by the image analysis unit.

Preferably, in the invention as described above, in the step (2) the wireless communication terminal transmits the telephone number assigned to and stored and maintained in the wireless communication terminal to the database managing server when the image data is transmitted, and in step (4) the database managing server checks the telephone number extracted from the image data against the telephone number stored and maintained in the communication interface and determines whether the personal information can be detected or not on the basis of the consistency therebetween.

Preferably, in the invention as described above, it is preferred to provide a step (6) of receiving and printing the personal information detected by the database managing server through the network by a printing unit.

Preferably, in the invention as described above, a paper identifier is printed on the handwriting image readable sheet in the form of encoded symbols for identifying the handwriting image readable sheet; in the step (2) the paper identifier is acquired together with the coordinate position, and transmitted to the database managing server; and in the step (6) the printing unit receives the paper identifier together with the personal information from the database managing server, and prints the paper identifier together with the personal information.

Preferably, in the invention as described above, the handwriting image readable sheet is an application sheet which is used for requesting the delivery of a postal matter, and wherein a paper medium to be printed by the printing unit is a transmittal slip which to be attached to the postal matter for showing the destination of the postal matter.

### BRIEF DESCRIPTION OF THE DRAWINGS

FIG. 1 is an explanatory view for showing a personal information management system in accordance with an embodiment which is applied to the delivery of postal matters.

FIG. 2 is a flow chart for showing the operation of the personal information management system in accordance with the embodiment.

FIG. 3 is an explanatory view for showing a personal information management system in accordance with a modification example.

FIG. 4 is an explanatory view for showing a personal information management system in accordance with another modification example.

### BEST MODE FOR CARRYING OUT THE INVENTION

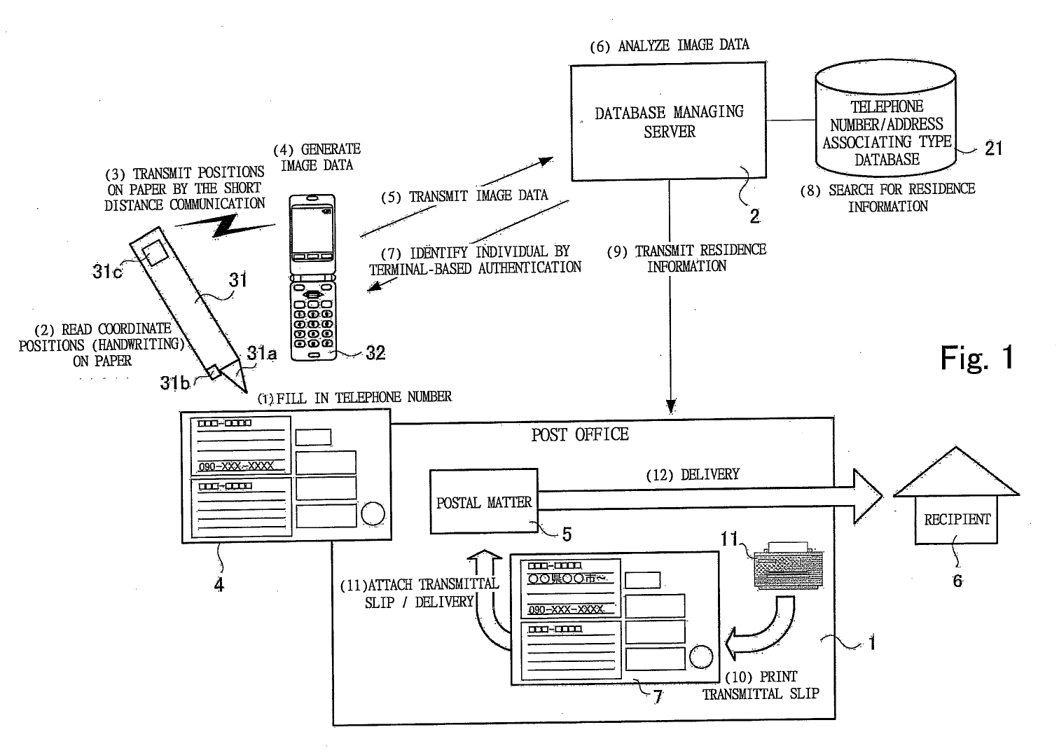

(Configuration of Personal Information Management System) An embodiment of the present invention will be explained with reference to the drawings. FIG. 1 is an explanatory view for showing a personal information management system in accordance with the present embodiment which is applied to the delivery of postal matters.

As shown in the same figure, the personal information management system of the present embodiment includes a cellular phone 32 which is used by a user, a database managing server 2 located in a network, and a digital pen 31 installed in a post office 1.

The network of the present embodiment is a distributed communication network which is constructed by connecting a variety of communication lines (telephone line, ISDN line, public network such as ADSL line, dedicated communication line, and radio communication network) to each other, and includes an IP network in which data transmission and reception can be performed, for example, by the use of the communication protocol TCP/IP. This IP network includes a LAN such as a home network, an intranet (a network within a company) based on 10BASE-T, 100BASE-TX or the like.

The database managing server 2 serves to manage a telephone number/address associating type database 21, and provided with the functionality of an authentication server which authenticates users. The telephone number/address associating type database 21 is a personal information database in which are stored personal information including either the residence or name of each user and the telephone number of the cellular phone 32 which is used by the each user in association with each other.

The digital pen 31 is a writing instrument for describing information on an application sheet 4 which is used for requesting the delivery of a postal matter, and provided with a writing member 31a such as a ballpoint pen or a mechanical pencil, and a camera 31b for reading a dot pattern on the handwriting image readable sheet. The writing member 31a and the camera 31b serve as a handwriting image reading unit which can read a handwriting image written by the writing member 31a. The application sheet 4 is a sheet used for requesting the delivery of the postal matter 5. However, in the case of the present embodiment, this application sheet 4 is provided with the functionality as a handwriting image readable sheet on which a dot pattern is printed in a space which the sender fills in. This dot pattern includes printed symbols in which are encoded the coordinate positions (for example, XY coordinates) and a paper identifier for identifying the paper type. A handwriting image on the sheet can be saved as image data by tracing the handwriting strokes performed with the writing member 31a, and continuously obtaining and analyzing the dot pattern.

In addition, the digital pen 31 is provided with a short distance communication interface 31c providing a Bluetooth, infrared or the like communication capability for transmitting the handwriting image captured by the camera 31b to the cellular phone 32.

The cellular phone 32 used by the user is a telephone equipment which is portable by the use of wireless communication for communicating with a relay point such as a base station without wires to receive communication services such as telephone conversation, data communication and so forth while moving. The communication methods for use in this type of cellular phones includes, for example, FDMA, TDMA, CDMA, W-CDMA, PHS (Personal Handyphone System) and so forth. Also, the cellular phone may be provided with functionalities such as digital camera functionality, application software execution functionality, and GPS functionality, and the functionality enabling the cellular phone to be used as a personal digital assistant (PDA). Incidentally, the cellular phone is described as an example of a wireless communication terminal for use in the present embodiment. However, the present invention is not limited thereto but can be implemented with a mobile computer.

This cellular phone 32 is provided with an image data generation unit for generating an image of handwriting written with the writing member 31a by analyzing the coordinate positions which are read and transmitted by the digital pen 31. This image data generation unit calculates the coordinate position of the digital pen 31 on the sheet by continuously reading the dot pattern and reproduces handwriting strokes on the basis of the motion of the coordinate position. Meanwhile, commands for switching the line color and the line type are associated with the coordinate positions so that when the coordinate positions are detected, the line color and type of the handwriting image to be reproduced are switched. Also, in the case of the present embodiment, the image data generation unit is provided in the cellular phone 32. The present invention is not limited thereto but the image data generation unit is provided in the digital pen 31.

Furthermore, the cellular phone 32 is provided with a communication interface for transmitting a paper identifier and image data generated by the image data generation unit to the database managing server 2 through the network. This communication interface serves to store and maintain the telephone number assigned to this wireless communication terminal, and is provided with the functionality of transmitting the telephone number as stored and maintained to the database managing server 2 when the image data is transmitted.

The database managing server 2 is provided with an image analysis unit which analyzes the image data which is received from the cellular phone 32 and extracts the telephone number assigned to the cellular phone 32. Also, the database managing server 2 detects the personal information associated with the telephone number from the telephone number/address associating type database 21 on the basis of the telephone number extracted by the image analysis unit. Furthermore, the database managing server 2 is provided with an authentication unit which checks the telephone number extracted from the image data against the telephone number stored and maintained in the cellular phone 32 and determines whether the personal information can be detected or not on the basis of the consistency therebetween.

The post office 1 is provided with a printer 11 which is connected to the database managing server 2 through the network and used to print the personal information which is detected by the database managing server 2. This printer 11 is a printing unit which prints a transmittal slip 7 to be attached to the postal matter 5. In the case of the present embodiment, the residences, names, telephone numbers of the sender and recipient are printed on the transmittal slip 7.

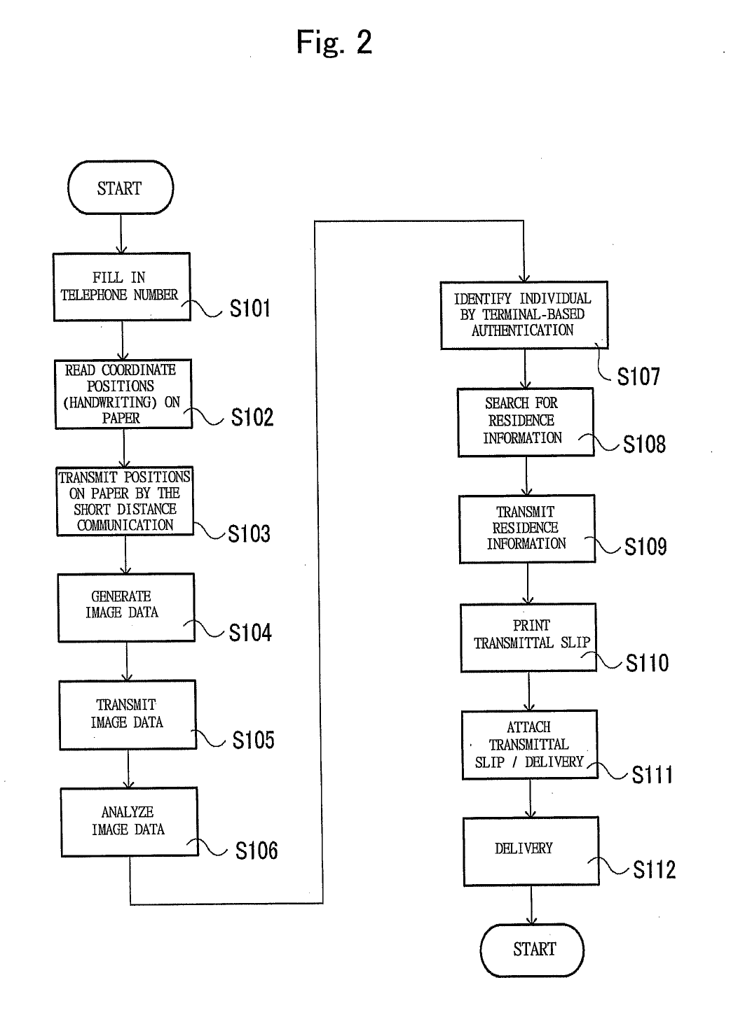

(Personal Information Management Method) The personal information management method in accordance with the present invention can be implemented by operating the personal information management system having the structure as described above. FIG. 2 is a flow chart for showing the operation of the personal information management system in accordance with the present embodiment. In this case, an example will be explained in the case where the sender who uses the cellular phone 32 requests the delivery of the postal matter 5 to the recipient 6.

As shown in the same figure, first, the sender brings the postal matter 5 to the post office 1 and applies for delivery. More specifically speaking, the sender writes the telephone number of the cellular phone 32 used by the sender on the application sheet 4 in the space for writing the sender's information with the digital pen 31 (step (1) of FIG. 1 and step S101 of FIG. 2). At this time, while the sender is writing with the writing member 31a, the camera 31b is reading the dot pattern on the application sheet 4 (step (2) of FIG. 1 and step S102 of FIG. 2). The paper identifier assigned to the application sheet 4 is also acquired by reading the dot pattern.

The handwriting strokes as read are transmitted to the cellular phone 32 by the short distance communication (step (3) of FIG. 1 and step 5103 of FIG. 2), and the image data generation unit of the cellular phone 32 generates the image of handwriting as written on the basis of the coordinate positions which are read by the camera 31b (step (4) of FIG. 1 and step S104 of FIG. 2). Then, the image data as generated and the paper identifier of the application sheet 4 are transmitted to the database managing server 2 through the network by the communication interface of the cellular phone 32 (step (5) of FIG. 1 and step S105 of FIG. 2).

Next, the database managing server 2 analyzes the received image data by the image analysis unit, and extracts the telephone number assigned to this wireless communication terminal and the paper identifier of the application sheet 4 (step (6) of FIG. 1 and step S106 of FIG. 2). The extracted telephone number is used to perform the terminal-based authentication of the cellular phone 32 and identify the sender (step (7) of FIG. 1 and step 5107 of FIG. 2).

More specifically speaking, the cellular phone 32 transmits the telephone number which is stored and maintained in the cellular phone 32 to the database managing server 2 when the image data is transmitted, and the database managing server 2 checks the telephone number extracted from the image data against the telephone number stored and maintained in the cellular phone 32 and determines whether the personal information can be detected or not on the basis of the consistency therebetween.

If this terminal-based authentication is successfully performed, the database managing server 2 extracts the telephone number extracted by the image analysis unit, and detects the personal information associated with this telephone number in the personal information database (step (8) of FIG. 1 and step 5108 of FIG. 2). The personal information is then transmitted to the post office 1 (step (9) of FIG. 1 and step S109 of FIG. 2).

The printer 11 located in the post office 1 receives the paper identifier and the personal information of the sender from the database managing server 2, and prints the transmittal slip 7 (step (10) of FIG. 1 and step S110 of FIG. 2). The paper identifier of the application sheet 4 is printed on this transmittal slip 7 together with the personal information such as the residence and name of the sender, and the telephone number of the sender. At the post office 1, the consistency between the sender's application and the transmittal slip 7 printed by the printer 11 can be confirmed by comparing the paper identifier described in the application sheet 4 with the paper identifier printed on the transmittal slip 7.

Then, at the post office 1, this transmittal slip 7 is attached to the postal matter 5 (step (11) of FIG. 1 and step S111 of FIG. 2), followed by starting the delivery (step (12) of FIG. 1 and step S112 of FIG. 2).

(Action/Effects of The Embodiment) As has been discussed above, in accordance with the personal information management system and method of the present embodiment, the information about the sender which is written on the application sheet 4 is only the telephone number of the cellular phone 32 used by the sender, and thereby it is possible to minimize the chance that the personal information is exposed when delivery application is made. In addition to this, since the residence of the sender and the like are automatically printed on the transmittal slip 7 only by filling in the telephone number of the cellular phone with the digital pen 31, the same information need not repeatedly be written to reduce the troublesome burden.

### Modification Examples

Meanwhile, in the case of the embodiment as described above, the personal information of the sender is identified on the basis of the telephone number of the cellular phone of the sender which is written in the application sheet. However, for example, the residence and the like information of the recipient may be identified on the basis of the telephone number of the cellular phone used by the recipient which is written.

Furthermore, in the case of the embodiment as described above, when delivery application is made, the application sheet 4 is filled in with the telephone number of the sender followed by printing the residences and the like of the sender and recipient on the transmittal slip 7. However, the contents to be printed can be switched depending upon in which step the delivery is done, for example, at the post office on the sender side, at the post office on the recipient side, or the like. For example, the system may be modified such that the application sheet 4 is filled in only with the telephone number of the recipient, that the residence of the recipient is printed on the transmittal slip 7 at the post office on the sender side, and that when the postal matter 5 is delivered to the post office on the recipient side, the personal information of the sender is additionally printed on the transmittal slip 7. In this case, since the telephone number of the sender is not written on the application sheet 4, the terminal-based authentication is performed by the use of another sheet. The result of the terminal-based authentication is preferably associated with the application sheet 4 on the basis of the paper identifier.

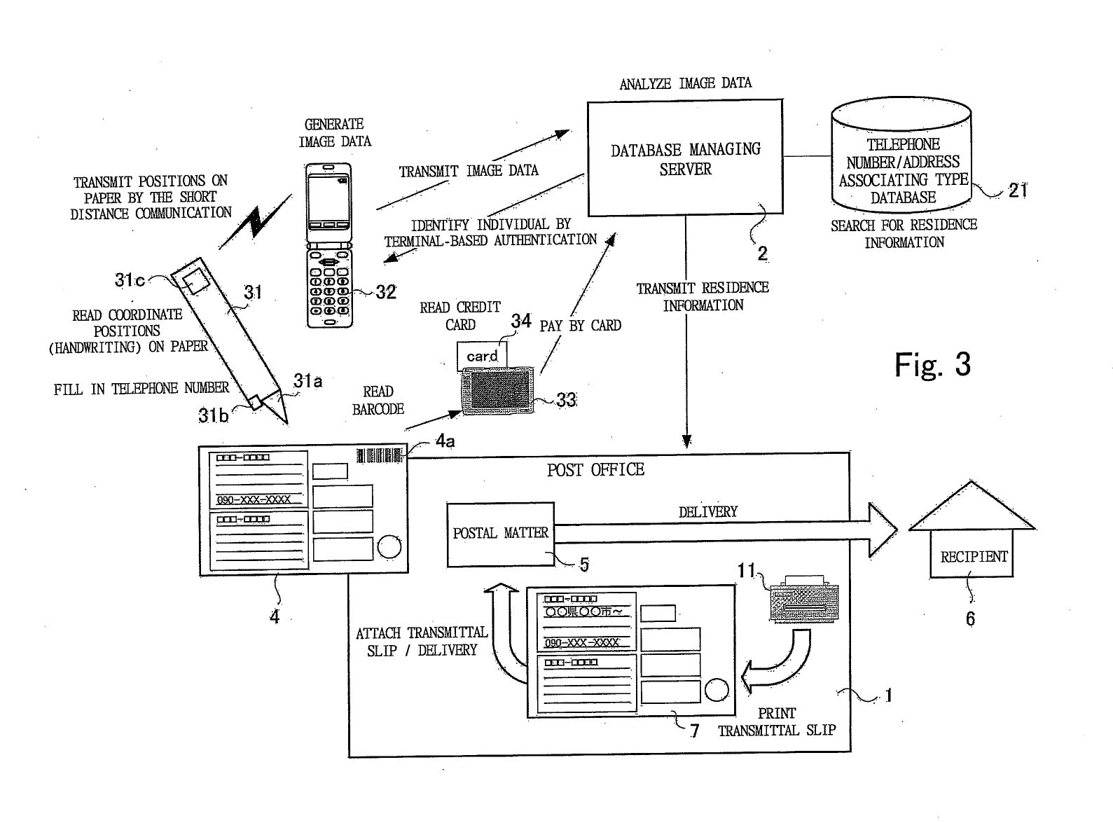

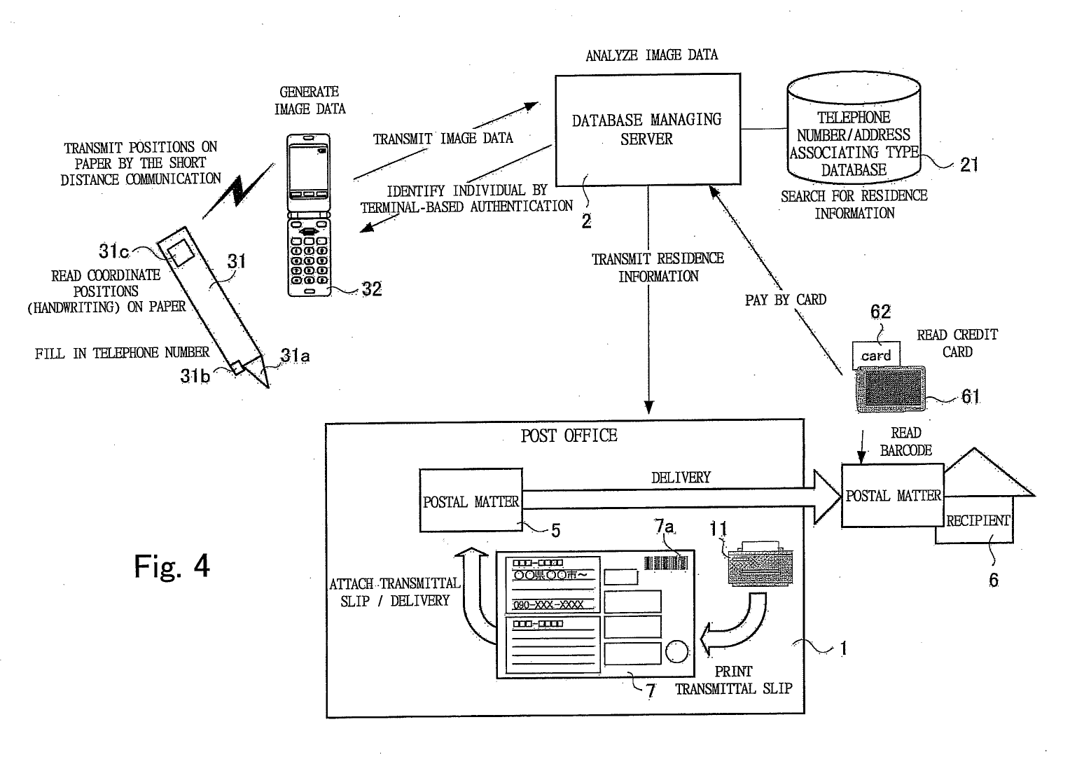

In addition, another modification example is such that, as illustrated in FIG. 3 and FIG. 4, the system is implemented further with a card reader 33 or 61 capable of reading a credit card 34 or 62 for payment for mailing cost on the sender side, payment on delivery or cash on delivery on the recipient side, or the like. These card readers 33 and 61 are devices which may be carried by postal workers and delivery persons on the sender side (origination side) and the recipient side, and can be used for performing authentication and settlement procedures between the delivery side and a financial institution on the network on the basis of the information of the credit card which is read. These card readers 33 and 61 are provided with bar code readers which is capable of reading barcodes 4a and 7a in which the paper identifier is encoded, and serves to decode the barcodes 4a and 7a printed on the application sheet 4 and the transmittal slip 7, and identify the application sheet 4 and the transmittal slip 7 by communicating with the database managing server 2.

By this configuration, it is possible to make payments such as payment on the sender side and payment on delivery by card, and ensure the delivery by identifying the sheet and slip on the basis of the barcodes 4a and 7a while minimizing the chance that the personal information is exposed.

### INDUSTRIAL APPLICABILITY

As has been discussed above, in accordance with the present invention, it is possible to minimize the chance that the personal information is exposed when a postal matter is delivered and thereby reduce the chance that the personal information is leaked, while the same information need not repeatedly be written to reduce the troublesome burden.

What is claimed is:

1. A personal information management system which manages personal information including the residences and names of individuals, comprising:
a personal information database in which are stored personal information including either the residence or the name of each of the individuals and the telephone number assigned to the wireless communication terminal used by the each individual in association with each other;
a database managing server located in the network and operable to manage the personal information database;
a handwriting image readable sheet on which coordinate positions of the sheet are printed in the form of encoded symbols;
a handwriting image reading unit operable to read the coordinate positions while writing a handwriting stoke on the sheet with a writing member;
an image data generation unit operable to generate the image of the handwriting written with the writing member on the basis of the coordinate positions read by the handwriting image reading unit;
a communication interface provided in the wireless communication terminal and operable to transmit the image data generated by the image data generation unit to the database managing server through the network; and
an image analysis unit provided in the database managing server and operable to analyze the image data received through the communication interface, and extract the telephone number assigned to the wireless communication terminal,
wherein the database managing server detects the personal information associated with the telephone number from the personal information database on the basis of the telephone number which is extracted by the image analysis unit.

2. The personal information management system as claimed in claim 1,
wherein the communication interface is provided with the functionality of storing and maintaining the telephone number assigned to the wireless communication terminal, and transmitting the telephone number which is stored and maintained to the database managing server when the image data is transmitted, and
wherein the database managing server is provided with the functionality of checking the telephone number extracted from the image data against the telephone number stored and maintained in the communication interface and determining whether the personal information can be detected or not on the basis of the consistency therebetween.

3. The personal information management system as claimed in claim 1 further comprising:
a printing unit which is connected to the database managing server through the network and operable to print the personal information detected by the database managing server.

4. The personal information management system as claimed in claim 1,
wherein a paper identifier is printed on the handwriting image readable sheet in the form of encoded symbols for identifying the handwriting image readable sheet,
wherein the handwriting image reading unit and the communication interface are provided with the functionality of acquiring and transmitting the paper identifier,
wherein the database managing server is provided with the functionality of transmitting the paper identifier received from the communication interface to the printing unit together with the personal information, and
wherein the printing unit is provided with the functionality of printing the paper identifier together with the personal information as received.

5. The personal information management system as claimed in claim 1,
wherein the handwriting image readable sheet is an application sheet which is used for requesting the delivery of a postal matter, and
wherein a paper medium to be printed by the printing unit is a transmittal slip which to be attached to the postal matter for showing the destination of the postal matter.

6. A personal information management method of managing personal information including the residences and names of individuals by a personal information database in which are stored the personal information including either the residence or the name of each of the individuals and the telephone number assigned to the wireless communication terminal used by the each individual in association with each other, the personal information management method comprising:
a step of writing a handwriting with a writing member on a handwriting image readable sheet on which coordinate positions of the sheet are printed in the form of encoded symbols, and concurrently reading the coordinate positions of the handwriting image readable sheet by a handwriting image reading unit;
a step of generating an image of the handwriting written with the writing member by an image data generation unit on the basis of the coordinate positions read by the handwriting image reading unit, and transmitting the generated image data to the database managing server by the wireless communication terminal through the network;
a step of analyzing the image data received from the wireless communication terminal by an image analysis unit of the database managing server, and extracting the telephone number assigned to the wireless communication terminal; and
a step of detecting the personal information associated with the telephone number from the personal information database on the basis of the telephone number which is extracted by the image analysis unit.

7. The personal information management method as claimed in claim 6,
wherein, in the step of generating an image of the handwriting, the wireless communication terminal transmits the telephone number assigned to and stored and maintained in the wireless communication terminal to the database managing server when the image data is transmitted, and
wherein, in the step of detecting the personal information, the database managing server checks the telephone number extracted from the image data against the telephone number stored and maintained in the communication interface and determines whether the personal information can be detected or not on the basis of the consistency therebetween.

8. The personal information management method as claimed in claim 6 further comprising:
a step of receiving and printing the personal information detected by the database managing server through the network by a printing unit.

9. The personal information management method as claimed in claim 8,
wherein a paper identifier is printed on the handwriting image readable sheet in the form of encoded symbols for identifying the handwriting image readable sheet,
wherein, in the step of generating an image of the handwriting, the paper identifier is acquired together with the coordinate position, and transmitted to the database managing server,
wherein, in the step of receiving and printing the personal information, the printing unit receives the paper identifier together with the personal information from the database managing server, and prints the paper identifier together with the personal information.

10. The personal information management method as claimed in claim 8,
wherein the handwriting image readable sheet is an application sheet which is used for requesting the delivery of a postal matter, and
wherein a paper medium to be printed by the printing unit is a transmittal slip which to be attached to the postal matter for showing the destination of the postal matter.
